(19) United States
(12) Patent Application Publication
(10) Pub. No.: US 2007/0031180 A1
(43) Pub. Date: Feb. 8, 2007

(54) EXTENDER STRIP

(76) Inventor: Guy B. Grogan, Lompoc, CA (US)

Correspondence Address: GREENBERG & LIEBERMAN, LLC, 2141 WISCONSIN AVE, N.W., SUITE C-2, WASHINGTON, DC, 20007, US

(21) Appl. No.: 11/160,781

(22) Filed: Jul. 8, 2005

(51) Int. Cl. B42F 13/02

(52) U.S. Cl. 402/8

(57) ABSTRACT

A flexible extender strip that can be attached to a table of contents divider so that the divider can be used in ringed binders to separate letter size eight and one-half inches by eleven inches (8½″×11″) documents where said documents have been placed in document protectors. The extender strip attaches to the table of contents divider in such a way that it extends the height of the divider outward when placed in the ringed binder, so that the protruding reference tab on the outside edge of the divider extends above the outside edge of all document protectors in the ringed binder. This extension of the divider allows the reference tab of the divider to extend well above the outside edges of document protectors inserted in ringed binders so that the reference tab can be easily located and distinguished as the dividing apparatus between the document protectors separated by the table of contents dividers.

### FIELD OF THE INVENTION

The present invention is an extension of a conventional divider so as to allow for use in three ring binders to separate letter size documents.

### BACKGROUND OF THE INVENTION

Using standard table of contents dividers in ringed binders to separate letter size documents that have been placed in document protectors has long been a problem. This is because the height of the document protectors completely hides the index tabs of standard table of content dividers when the dividers are placed in ringed binders along with the document protectors. The top outside edge of the document protectors extend outward past the top edge of the index tabs of the dividers, completely covering the index tabs of the dividers and making it impossible to determine where the dividers separate the document protectors in the binders. As a result, when looking at a ringed binder containing document protectors and table of contents dividers it is impossible to tell that the dividers are present, and at what point the dividers separate the document protectors. Because the table of contents dividers are completely hidden by the document protectors, the ringed binder looks as if it contains only the document protectors and their inserted documents, but no dividers.

Thus there is a need for a device that will extend the conventional table of contents dividers.

In the past the only other option to using table of contents dividers in binders to separate document protectors was to use oversized cardboard dividers as separators, or use self-adhesive tabs that attach to the document protectors themselves. A major problem with cardboard dividers is that they are not readily made in the size required. Most cardboard dividers must be purchased over-sized and then the edges trimmed to fit the confines of the ringed binder. In many cases to get the cardboard divider to fit the binder additional holes must be added to the divider by punching, using some type of hole punching device. Both trimming to size and punching holes require the purchase of additional office equipment, if it is not already available. Additionally, cardboard dividers are bulky when compared to the standard divider, and they are not available in as wide a range of material and design compositions as the standard table of content dividers are.

Thus there is a need for a device that fits with in a conventional binder with out the need to alter the size by cutting, folding or punching holes in it.

The problem with self-adhesive tabs is that each tab must be visually aligned and manually attached to each document protector that is used as a divider. Manually attached self-adhesive tabs are less accurately positioned then the preformed tabs on table of contents dividers, therefore, they do not fit uniformly and present a less professional appearance. This severely detracts from their use in business applications. When necessary to organize large numbers of binders and documents, manually aligning and attaching self-adhesive tabs is tedious and time consuming when compared to using table of content dividers.

Thus there is a need for a device that will self-align and attach with little effort and still maintain a professional appearance.

U.S. Pat. No. 4,990,018 issued to Best on Feb. 5, 1991 shows a multiple ring binder adapter for a negative. Unlike the present invention Best's invention is intended to store photographic negative film without damaging them.

U.S. Pat. No. 5,842,720 issued to Ward on Dec. 1, 1998 shows pressure sensitive reinforcement strips for loose leaf pages. Unlike the present invention, Ward's invention is intended to reinforce the pre cut holes of loose leaf pages so as to prevent and or fix rips.

U.S. Pat. No. 6,019,539 issued to Lynton on Feb. 1, 2000 shows a flexible sheet protector. Unlike the present invention, Lynton's invention is for protecting pages and is not intended to extend a page beyond the edge of others for better visibility.

### SUMMARY OF THE INVENTION

The present invention is intended primarily for attaching to standard table of contents dividers that are commonly used in three ringed binders. The subject invention extends the height of the table of contents divider so that the divider can be seen as the separating apparatus when the divider is used in ringed binders in conjunction with document protectors. It ensures that the index tab of the table of contents divider is easily visible and distinguishable as the separating apparatus of documents, or other media, that have been placed in document protectors when such document protectors are placed in ringed binders. When the present invention is attached to a table of contents divider, and the complete assembly is placed in the ringed binder along with document protectors containing media, the height of the table of contents divider is extended so that the locator tab of the divider protrudes an additional three quarters of an inch (¾″) higher in the ringed binder than normal. When placed in the present invention and placed in ringed binders, the additional height provided by the present invention allows the locator tab of the table of contents divider, to be seen as the point of separation between the document protectors and their inserted documents.

The significant advantage of this invention is that it supports and enhances the functionality of a proven product, standard table of content dividers, already on the market, by making the dividers available for wider use by consumers. Whether home office or small business, corporate or government, industrial or scientific, the present invention permits existing dividers to be used as separators, concurrent with document protectors, in ringed binders utilized for such purposes as personnel training, shop procedures, industrial equipment operating instructions, and formal briefings and presentations. For sales purposes the present invention can be marketed along side table of content dividers to stimulate sales of both the present invention and the dividers.

To further expand its uses the present invention can be accentuated with vibrant colors and prints to match the color of the table of contents divider and/or index tab, and can be made of reinforced paper/cloth, instead of the transparent plastic sheet material described herein. Color range and vibrancy would depend on the material used. The present invention is not limited to use with standard 8½×11″ table of contents dividers. It can be made in different lengths, depths, and with different numbers, sizes, and series of binder holes to allow it's use for the insertion of any paper leaf intended for use in a ringed binder, where the leaf must be extended in height to make it readily distinguishable as the separating apparatus within the ringed binder.

Additionally the present invention without any holes could be made in different lengths. The absence of holes allows the user to punch holes as desired to fit the binder(s) of their choice. The user can cut and shape the length of the strip and punch holes, as desired for their particular application. This allows the hole-less strip to be used with scrapbooks, recipe books, odd sized documents and large photos, or other paper (or similar) media having an edge that will allow you to attach a strip to it, and then place the media in a ringed binder or other display/retaining apparatus. The longitudinal flap of these strips can be of different widths to grip and cover more or less of the media's edge, depending on the application. Or the flap can be made in widths to be trimmed as desired.

### BRIEF DESCRIPTION OF THE DRAWINGS

FIG. 1 is a front view of the outside of the present invention showing the location of the inside and outside longitudinal sections, the seam that joins and reinforces the area between the two sections, the crevice, the binder ring retaining holes, and the pressure sensitive adhesive, the latter being shown in phantom line;

FIG. 2 is a front view of the inside of the present invention as it might appear during the manufacture process, showing the two identical halves that, when folded and joined at the seam, form the present invention;

FIG. 3 is an environmental view of the present invention and shows the relative positioning of the table of contents divider to the present invention in preparation for insertion of the table of contents divider into the present invention;

FIG. 4 is a top view of the present invention with the two outside flaps lifted, the table of contents divider inserted between the flaps, and the flexible backing being removed from the pressure sensitive adhesive on the inside surface of both flaps of the present invention, in preparation for securing the flaps of the present invention to the table of contents divider as shown in FIG. 6; the bottom view is a mirror image of FIG. 4;

FIG. 5 is an environmental view of the two outside flaps of the present invention, and the flexible protective backing being removed from the pressure sensitive adhesive on inside surface of each flap, prior to securing the flaps to the table of contents divider;

FIG. 6 is an top view of the present invention with the table of contents divider inserted between the two outside flaps of the present invention and secured between the two flaps by the pressure sensitive adhesive on the inside surface of each flap;

FIG. 7 is an environmental view of the present invention, with table of contents divider secured, inserted into a standard three ring binder, and showing how, with the use of the present invention, the holes of the table of contents divider become hidden.

### DETAILED DESCRIPTION OF THE PREFERRED EMBODIMENT(S)

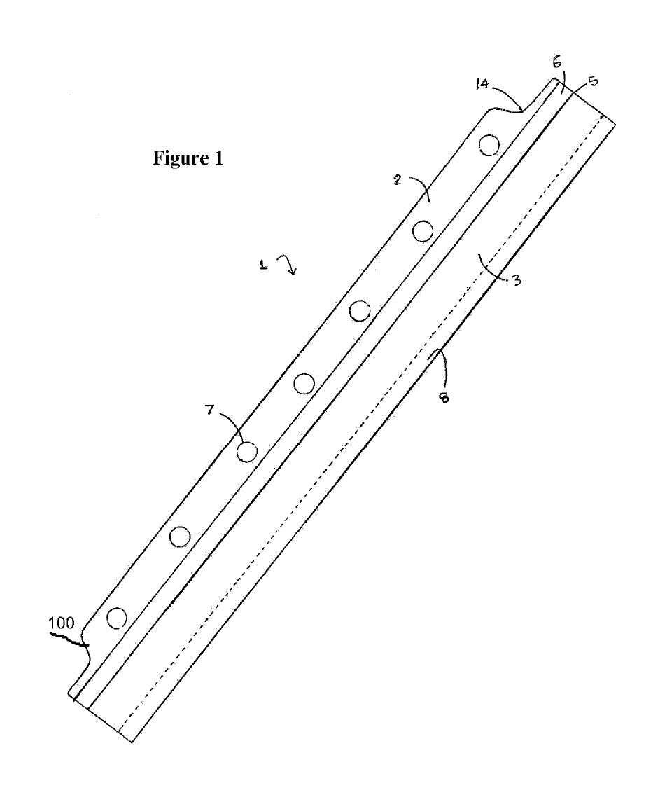

Referring to the drawings, the present invention is generally shown in FIG. 1. The extender strip (1) is used to extend the height of a table of contents divider, when said divider is used in a conventional loose leaf type binder where the conventional binder is meant to contain paper, or other similar documents, inserted into conventional document protectors. The extender strip (1) is made of a reasonably strong but flexible gauge polymer or polyethylene material.

The one-piece extender strip (1) has the inside longitudinal section (2), the outside longitudinal section (3), and a seam (6), that together provide the extending means. The seam (6) is a bonded portion of the inside longitudinal section (2) that helps to join and strengthen the two identical halves of the extender strip (1) formed during the manufacturing process. The seam (6) also serves to separate the functions of the inside longitudinal section (2) and the outside longitudinal section (3) of the extender strip (1) and is the means by which the crevice (5) is formed as part of the outside longitudinal section (3).

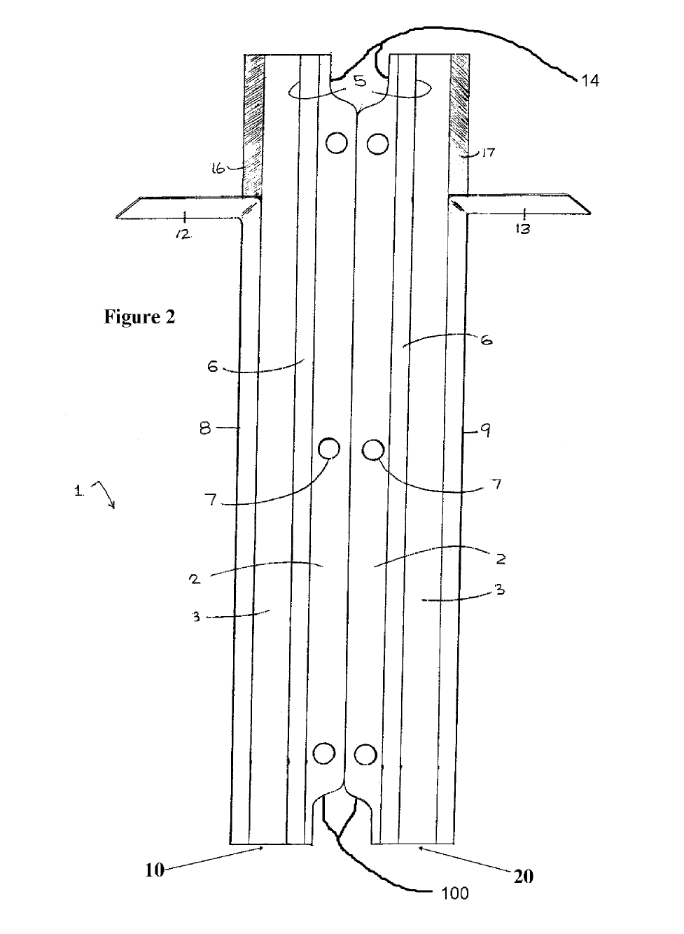

The inside longitudinal section (2) is a bonded solid piece with a series of binding holes (7). The binding holes (7) are spaced and positioned to correspond with the location of the conventional binding hole rings (not shown) found in a conventional loose-leaf binder. The holes (7) allow the extender strip (1) to be aligned with the conventional binding hole posts and inserted into the conventional binder. The far edges (14, 100) on each end of the inside longitudinal section (2) of the extender strip (1) are tapered for a more aesthetic and professional look of the extender strip (1) when used in conventional loose-leaf binders. [Para 25]As best seen in FIG. 2, the outside longitudinal section (3) consists of two opposing flaps (8) and (9) that form at the outermost point of the seam (6). The junction of flaps (8) and (9) at the seam (6) forms the crevice (5) of the extender strip (1), and marks the beginning of the outside longitudinal section (3). The inside top-most portions of flaps (8) and (9) of the outside longitudinal section (3) have pressure sensitive adhesive strips (16) and (17) extending along the entire longitudinal edge of each flap (8 and 9). The adhesive strips (16 and 17) are covered by a removable mylar, or other light flexible plastic protective backing (12 and 13), for use in protecting the pressure sensitive adhesive until ready for exposure to permit use of the extender strip (1). The adhesive strips (16 and 17) are visible at flaps (8 and 9) of the extender strip (1), when viewing a transparent production of the extender strip (1) from the outside. The adhesive strips (16 and 17) are not visible from the outside of the extender means (1) when viewing color productions of the extender strip (1). The adhesive strips (16 and 17) applied along the outside longitudinal section (3) of the extender strip (1) may be composed of a permanent or semi-permanent adhesive, depending upon the intended longevity of the extender strip (1) when utilized for the intended purpose.

The drawing of the extender strip (1) at FIG. 2 is a front view of the present invention as it might be developed for production. The drawing is a representation of the extender strip (1) as viewed when unbonded and dissected to open outward along its entire longitudinal length beginning at the opposing flaps (8 and 9), and the crevice (5) of the outside longitudinal section (3) of the extender strip (1), and progressing inward through the inside longitudinal section (2), including seam (6), before finally opening to form an illustration of the two identical halves, (10 and 20) that form the extender strip (1). The binding holes (7) on both halves of the inside longitudinal sections (2) are located equidistant from each other and form single apertures when the two halves of the extender strip (1) are bonded together. The binding holes (7) are located at the appropriate distances on the inside longitudinal section (2) to facilitate alignment and insertion of the holes (7) onto the conventional binding posts of a conventional loose-leaf binder. When the two identical halves (10 and 20) are bonded they further create the crevice (5), and opposing flaps (8 and 9), as part of the outside longitudinal section (3), at the top of the seam (6).

As aforementioned, illustrated as part of the outside longitudinal section (3) are the adhesive strips (16 and 17) that are applied to the outermost edges of the opposing flaps (8 and 9) during the manufacturing process. The removable protective backing (12 and 13) protects the pressure sensitive adhesive strips (16 and 17) and is illustrated in FIG. 2 as being partially peeled away from the adhesive strips (16 and 17) in preparation for use of the extender strip (1). When removed in its entirety, the protective backing (12 and 13) exposes the adhesive strips (16 and 17) for use of the extender (1).

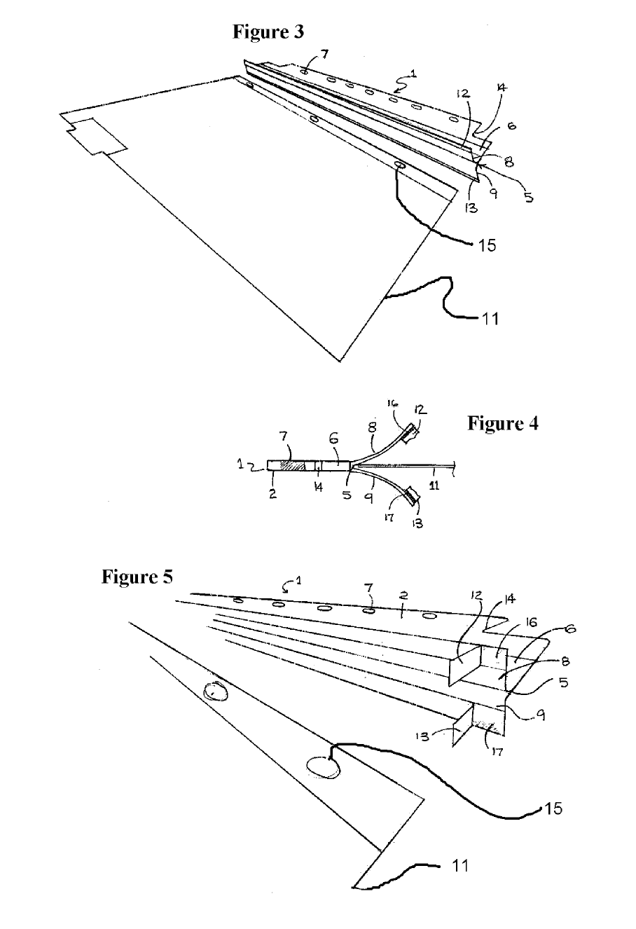

FIG. 3 is an environmental view of the extender strip (1) in preparation for use with a conventional table of contents divider (11). This view illustrates the relative position of the conventional divider (11) to the extender strip (1) for insertion of the conventional divider (11) into the crevice (5), and the position of the opposing flaps (8 and 9) when retracted back to permit exposure of the crevice (5) for insertion of the conventional divider (11) into the crevice (5). Shown also is the removable protective backing (12 and 13), located on the outer edge of the opposing flaps (8 and 9), before removal of the backing (12 and 13) to expose the adhesive strips (16 and 17) underneath. The relative position of the seam (6) to the crevice (5) is also shown. In preparation for use of the extender strip (1) it is not required that both opposing flaps (8 and 9) be pulled back simultaneously as illustrated in the drawing, to permit insertion of the conventional divider (11). Conventional binder holes (15) are shown on conventional divider (11).

FIG. 4 is a detailed top view of the extender strip (1) with table of contents divider (11) inserted into the crevice (5) of the extender strip (1), and opposing flaps (8 and 9) retracted just prior to attachment of opposing flaps (8 and 9) to the divider 11). As can be seen, the protective backing (12 and 13) is being pulled away to expose conventional pressure sensitive adhesive on the adhesive strips (16 and 17). The location of the seam (6) on the inside longitudinal section (2) is shown, as is the location of the conventional loose-leaf binder hole (7) of inside longitudinal section (2).

FIG. 5 is an environmental view of the extender strip (1) being prepared for use with the standard table of contents divider (11). The flexible protective backing (12 and 13) is being removed exposing the pressure sensitive adhesive strips (16 and 17) located on inside surface of opposing flaps (8 and 9). The drawing also illustrates the relative positions of the crevice (5), seam (6), and loose-leaf binder holes (7), on the inside longitudinal section (2). As described in FIG. 3, the opposing flaps (8 and 9) of the extender strip (1) cover the conventional binder holes (15) of the conventional table of contents divider (11) when the divider (11) is inserted into the crevice (5) of the extender strip (1).

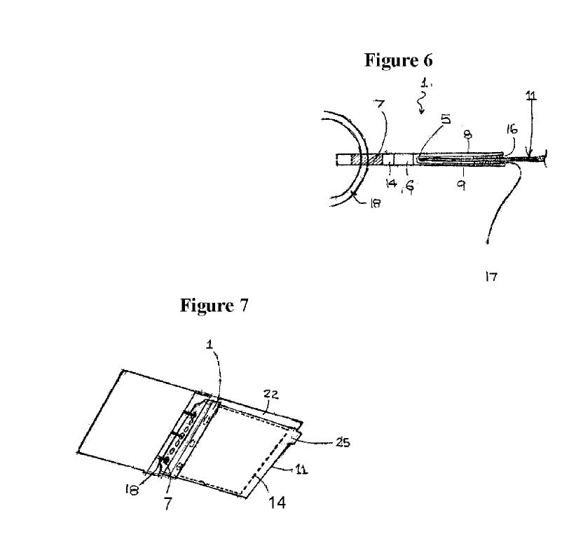

The representation in FIG. 6 is a top view of the conventional table of contents divider (11) inserted into the extender strip (1) and in use. The representation shows the location of the table of contents divider (11) when inserted into the crevice (5), and held in place by the pressure sensitive adhesive strips (16 and 17) located at the outside edge of the opposing flaps (8 and 9). The flexible protective backing (12 and 13) shown in previous illustrations subsequent to the current have since been removed from the pressure sensitive adhesive (16 and 17) and discarded. The illustration also shows the position of the extender strip (1) with contents divider (11), as inserted over the conventional binding post (18) of a conventional loose-leaf binder (22), as shown in FIG. 7, and thereby ready for use.

The illustration at FIG. 7, provides an environmental view of the extender strip (1) with table of contents divider (11) inserted, as placed in the conventional loose-leaf binder (22) for use. The drawing at FIG. 7 shows the relative position of the extender strip (1) and divider (11) when placed in the loose-leaf binder (22) for use. In the illustration, the extender strip (1) with divider (11) has been inserted onto the binding posts (18) of the binder (22) through the binder holes (7) in the extender strip (1).

Variations of the extender strip (1) may be made of semi-flexible fiber paper, or other suitable paper material, depending upon the other uses for which the strip is developed; it may even be made of stiffened cloth materials. The extender strip (1) may be made in numerous length and width combinations for use in a wide range of applications. Examples of other applications for the extender strip (1) are: as a height adjustment sleeve for compact disk jackets in compact disk binders utilized for music, movie, and other compact disks; adjustment sleeve for inserting non-compatible sized documents or document protectors into non-compatible binders; as an insertion tool for scrap book binder pages.

The present invention as described and illustrated herein can be designed in a number of different or modified configurations. Therefore, the details of the invention as described herein are not intended to limit the scope of the invention, but to provide a reference for the explanation and application of the invention in its current configuration as described herein.

What is claimed is:

1. An apparatus for extending a conventional table of contents divider, comprising:
a first longitudinal section;
a second longitudinal section in communication with said first longitudinal section;
two flaps in communication with said second longitudinal section; and
a crevice in communication with said first longitudinal section and said second longitudinal section.

2. The apparatus of claim 1, wherein said first longitudinal section has a seam.

3. The apparatus of claim 2, wherein said seam is a bonded portion.

4. The apparatus of claim 2, wherein said seam serves as the point of communication between said first longitudinal section and said second longitudinal section.

5. The apparatus of claim 1, further comprising at least one hole in communication with said first longitudinal section.

6. The apparatus of claim 5, wherein said at one hole is spaced and positioned to correspond with the location of conventional binding hole rings found in a conventional loose-leaf binder.

7. The apparatus of claim 1, wherein said first longitudinal section has tapered far edges.

8. The apparatus of claim 1, further comprising an attaching means in communication with said two flaps.

9. The apparatus of claim 8 wherein said attaching means is two adhesive strips.
